(19) United States
(12) Patent Application Publication
(10) Pub. No.: US 2012/0103173 A1
(43) Pub. Date: May 3, 2012

(54) Human-Machine Interface

(75) Inventor: Rémi Dury, Ris Orangis (FR)

(73) Assignee: DA FACT, Paris (FR)

(21) Appl. No.: 13/262,452

(22) PCT Filed: Mar. 23, 2010
(86) PCT No.: PCT/FR2010/050517

§ 371 Date: Dec. 30, 2011

(30) Foreign Application Priority Data
Mar. 31, 2009 (FR) 0952060

(51) Int. Cl. G10H 1/34

(52) U.S. Cl. 84/746

(57) ABSTRACT

The invention relates to a human-machine interface (1), including a first body (10), a second body (11) and a controller (12), the first and second bodies (10), (11) being axially linked and rotatably movable, the first body (10) supporting a platform (100), the second body (11) supporting a feeler (110) in contact with the helical platform (100), and the controller (12) including a sensor (120) outputting a signal depending on the position of the feeler (110) on the platform (100). According to the invention, the human-machine interface includes: urging means (13) for applying a resilient bearing force in order to urge the feeler (110) and the platform (100); the first and second bodies (10), (11) not being axially translatable; and one of the elements consisting of the feeler (110) and the platform (100) being mounted so as to be axially slidable relative to the first and second bodies (10), (11).

### FIELD OF THE INVENTION

The invention relates to a human-machine interface for controlling an electronic equipment and more particularly for monitoring a musical equipment.

### BACKGROUND OF THE INVENTION

More specifically, the invention relates to a human-machine interface comprising a first body, a second body, and at least a first controller, the first and second bodies being linked to each other, aligned along a longitudinal axis, and rotatably movable with respect to each other around the longitudinal axis, the first body supporting a helical platform extending at a distance from the longitudinal axis in a slanted plane with respect to this axis, the second body supporting a feeler mounted in sliding contact on the platform, and the first controller comprising a first sensor outputting a first signal depending on a position adopted by the feeler on the platform.

Such human-machine interface is known by the skilled person, as is shown by international patent WO 2005/109398. By moving the feeler over the helical platform of the human-machine interface known for generating the first signal, the axial spacing between the first and second bodies is changed. This is bothersome for the human-machine interface operator. Furthermore, the movement of both bodies with respect to each other along the longitudinal axis allows entry of dust or liquid inside the human-machine interface, thus leading to the risk of altering the operation of the human-machine interface as well as wear and premature ageing problems.

The purpose of the present invention, based on this original observation, is to particularly provide a human-machine interface aiming to remedy to at least one of the aforementioned limitations.

To this end, the human-machine interface, which is furthermore in accordance with the generic definition given in the above preamble, is particularly characterized:
in that it further comprises at least first urging means for applying a first resilient bearing force in order to urge the feeler and the platform against each other,
in that the first and second bodies are fixed in translation with respect to each other along the longitudinal axis, and
in that one of the members constituted by the feeler and the platform is slidingly mounted along the longitudinal axis with respect to the first and second bodies.

Owing to this arrangement, the first and second bodies remain fixed in translation with respect to each other along the longitudinal axis when the feeler moves over the platform (to generate the first signal). Thereby, the operator has a better mastery of the human-machine interface. Being less tired, the operator has an easier and a more precise command of his controls during an extended use of the human-machine interface (for example, during several hours of on-stage repetition and representation during a concert). Furthermore, the first and second bodies being immobile in an axial translation, the penetration of soiling inside the human-machine interface is very unlikely, thus contributing to reduce wear and premature ageing problems and making the human-machine interface more robust.

According to an embodiment, the human-machine interface further comprises second urging means, different from the first urging means and able to exert a second resilient bearing force making the first and second bodies closer to each other along the longitudinal axis.

Owing to this arrangement, the first and second bodies are maintained axially close to each other in a controlled manner, with the second resilient bearing force mastered by the second urging means, independently from the first resilient bearing force urging the feeler and the platform against each other.

Preferably, the human-machine interface further comprises a module including first and second portions and the second urging means. The first and second portions are respectively fixed to the first and second bodies. The first and second portions are fixed in translation and rotatably movable with respect to each other around the longitudinal axis. The second resilient bearing force makes the first and second portions of the module closer to each other along the longitudinal axis.

Owing to said module, it is possible to ensure a reliable connection between the first and second bodies of the human-machine interface.

Advantageously, the module may further comprise an axial shaft, the second urging means may comprise at least a spring and two bearing members supported by the shaft and at least one of which includes a screw engaged on a threading of the shaft. The two portions of the module and the spring together form a stacking axially traversed by the shaft and squeezed between the two bearing members. The second resilient bearing force is exerted in an adjustable manner by a spring load o resulting from a screwing of the screw on the shaft.

Owing to this arrangement, it is possible to finely adjust, through the spring load during screwing (with a predetermined pitch), the second resilient bearing force and, consequently, the friction force applied between the first and second portions of the module, during their rotation with respect to each other around the longitudinal axis.

Preferably, the first and second portions of the module have respective friction surfaces applied against one another, of identical or different nature, and whereof each is at least constituted of a material selected from the group of: aluminum, metal or metal alloy, plastic material, and polyoxymethylene.

The friction force between the first and second portions of the module is defined by two independent parameters, namely by the second aforementioned resilient bearing force on the one hand, and by a friction coefficient between the friction surfaces on the other hand. A selective choice of the nature of the friction surfaces makes it possible to modify the friction coefficient and, as a consequence, to further adjust said friction force. The latter makes it possible to adjust a minimal muscular stress which the operator has to apply using the human-machine interface to put the first and second bodies in relative rotation. A satisfactory adjustment of this “threshold” of muscular stress makes it possible to avoid, at the same time, any premature tiredness on the part of the operator handling the human-machine interface and prohibit a free unmonitored rotation of the two bodies with respect to each other, for example, under the effect of gravity. This results in a decrease in the rate of erroneous signals emitted by the human-machine interface.

According to an alternative, the helical platform takes the form of a frontal surface provided on the first portion of the module, the feeler takes the form of a slidingly mounted stud, under the solicitation of the first resilient bearing force, in parallel to the longitudinal axis and in a housing of the second portion of the module, and the first sensor is responsive to the sliding position of the stud.

Owing to this arrangement, it is possible to protect, by said housing, the stud sliding over the platform from all involuntary solicitations such as jolts during the use of the human-machine interface by the operator. This contributes to secure an expected operation of the first sensor and, in fine, makes the human-machine interface more robust.

Preferably, the platform provides the feeler with a effective travel corresponding to a relative rotation of the two bodies around the longitudinal axis at the most equal to 70°.

Owing to this arrangement, the human-machine interface exhibits ergonomics in accordance with the anatomical constitution of the operator (given that said anatomical constitution determines, inter alia, an optimal amplitude of the operator movements). Consequently, the operator may easily handle the human-machine interface. This contributes to reduce the tiredness of the operator using the human-machine interface in an extended manner, for example, for several hours of on-stage presentation during a concert, particularly when the operator spreads his forearms and elbows in order to ensure said relative rotation of two bodies of the human-machine interface (each of the operator hands remaining on one or the other, first or second, bodies of the human-machine interface).

Preferably, the module further comprises at least a first elastic end-of-travel stop limiting the travel of the feeler to a first end of the platform. The first elastic stop at least provided with a second sensor outputting a second control signal depending on a first stress exerted on this first elastic stop.

Owing to this arrangement, the operator can, in one rotation of the first body with respect to the second body in a privileged sense (and, thus, in one single privileged movement of the arms, for example, by spreading the forearms and the elbows apart), emit at least two signals: on the one hand, the first signal generated by the first sensor sliding along the effective travel of the feeler on the platform, and on the other hand, the second signal generated by the second sensor under the action of the first elastic end-of-travel stop. This enriches a range of controls available to the operator through the human-machine interface.

Preferably, the module further comprises at least a second elastic end-of-travel stop, limiting the travel of the feeler to a second end of the platform, at a distance from the first end, and the second elastic stop at least provided with a third sensor outputting a third control signal depending on a second stress exerted on this second elastic stop.

Owing to this arrangement, during the rotation of the first body with respect to the second body of the interface in a direction opposed to the privileged one (for example, by bringing his/her forearms and elbows closer to each other), the operator may emit the third signal generated by the third sensor under the action of the second elastic stop. This further enriches the range of controls available to the operator through the human-machine interface.

Advantageously, each elastic stop may be adapted to limit the relative rotation of the two bodies around the longitudinal axis at the most equal to 17° beyond the effective travel of the feeler over the platform.

Owing to this arrangement, the ergonomics of the human-machine interface conforms more to the anatomical constitution of the operator, thus contributing to make the handling of the interface easier, and reducing the operators tiredness and to keep all fingers of the right and left hand free, including when the operator handles the human-machine interface such as to slant the longitudinal axis of the human-machine interface with respect to gravity.

Preferably, each elastic stop is provided on one of the two portions of the module, and a spur parallel to the stud and fixed to the other portion of the module, is provided to press on each end-of-travel stop of the stud on the platform.

Owing to this arrangement, the bearing stress on the elastic stop is exerted, transversally to the longitudinal axis, by the spur and not by the stud. This contributes to protect the stud from any unexpected deformation that may damage it during the relative rotation of the first and second bodies. To this end, the human-machine interface becomes more robust.

Other characteristics and advantages of the invention will become apparent from the following description, for reference only and in no way limiting, with reference to the accompanying drawings, wherein:

### BRIEF DESCRIPTION OF THE DRAWINGS

FIG. 1 schematically represents in a simplified top view a human-machine interface according to the invention,

FIG. 2 schematically represents in a simplified side view the human-machine interface according to the invention,

FIG. 3 schematically represents in a simplified side view a module connecting a first and a second body of the human-machine interface along a longitudinal axis according to the invention, the module comprising a first and a second portion fixed in translation on an axial shaft and rotatably movable with respect to one another around the longitudinal axis,

FIG. 4 schematically represents said module in simplified exploded tridimensional view,

FIG. 5 schematically represents a simplified partial longitudinal cross-section of said module, in a MM plane parallel to the longitudinal axis,

FIG. 6 schematically represents in a simplified top view the second portion of said module,

FIGS. 7-9, 10-12, 13-15, 16-18 and 19-21 respectively schematically illustrate five different positions of said module during the rotation of the first portion with respect to the second portion: using simplified partial transversal cross-sections in a EE plane perpendicular to the longitudinal axis (FIGS. 7, 10, 13, 16, 19): using simplified partial longitudinal cross-sections, in said MM plane parallel to the longitudinal axis (FIGS. 8, 11, 14, 17, 20); using simplified partial bottom views of the first portion of the module (FIGS. 9, 12, 15, 18, 21).

### DETAILED DESCRIPTION OF THE INVENTION

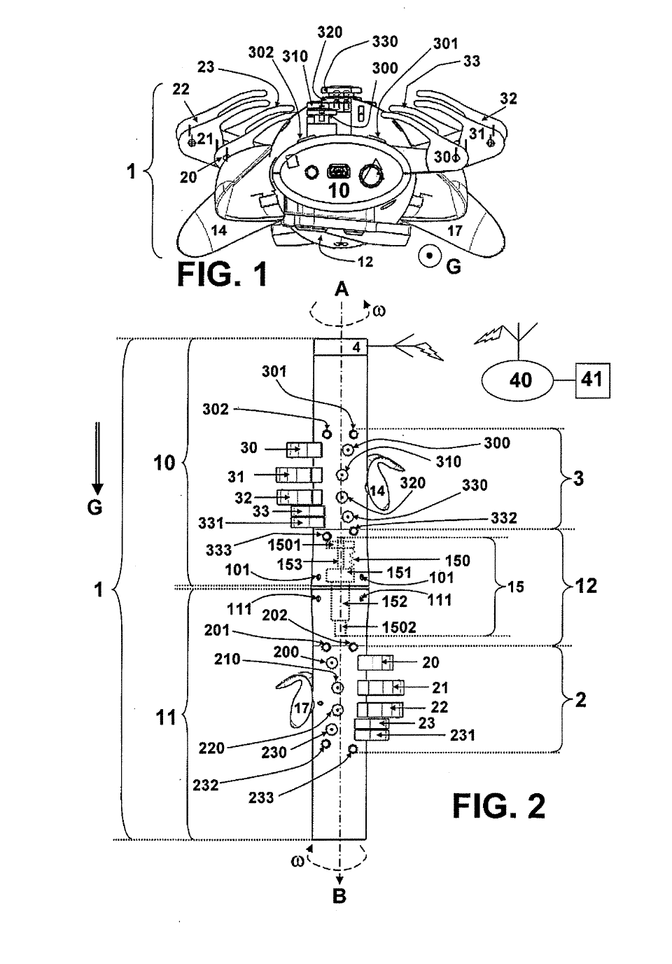

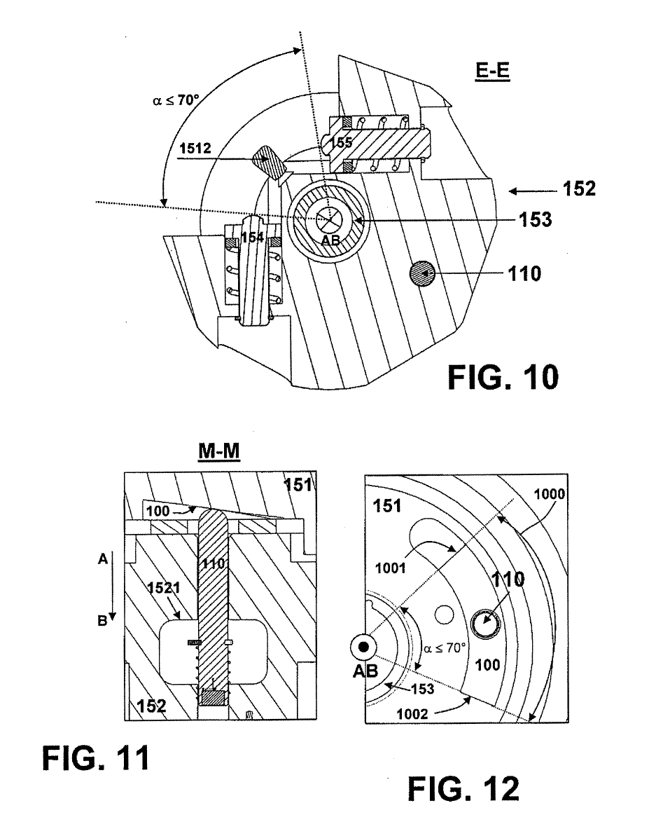

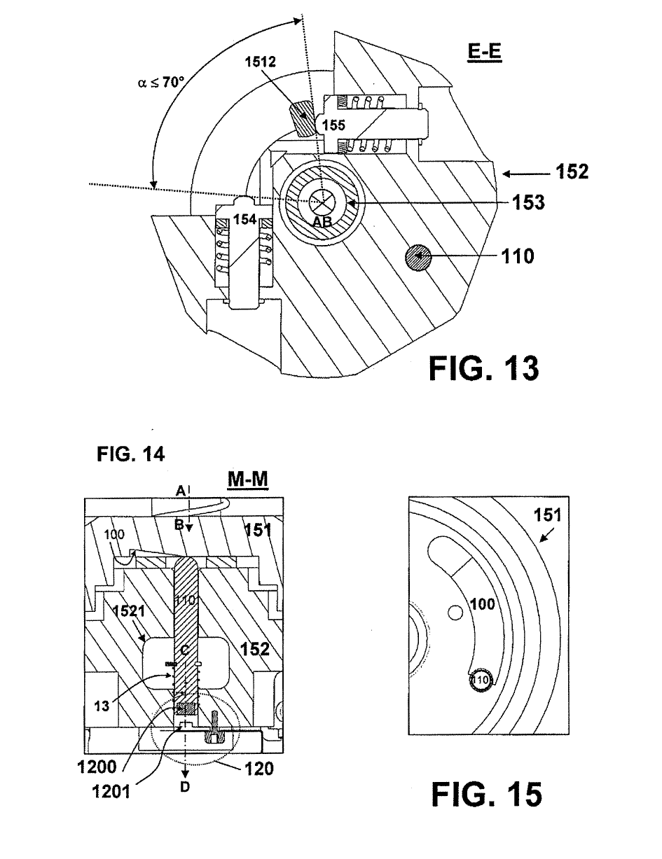

As previously stated and illustrated on FIGS. 1-21, the invention relates to a human-machine interface 1 comprising a first body 10, a second body 11, and at least a first controlling member 12. The first and second bodies 10, 11 are connected to each other and are aligned along a longitudinal axis AB (FIG. 1), exhibiting a total axial length typically lower than 0.6 m. The first and second bodies 10 and 11 are, preferably, tubular, each exhibiting a section that is transversal to the longitudinal axis AB lower than 8 centimeters. The axial length of the human-machine interface 1, the tubular shape of the first and second bodies 10 and 11, their respective transversal sections are adapted to the human morphology, to make it possible for an operator (for example, for a musician in standing or sitting position) holding the human-machine interface 1 in his/her hands, to easily handle the human-machine interface 1 for a prolonged time (for example, during a concert of a duration of several hours).

The FIGS. 1-2 exhibit an example of the human-machine interface 1 adapted to a right-handed operator holding:
the first body 10 with his/her right hand using a first anatomical handle 14, the palm of his/her right hand surrounding the first anatomical handle 14, the thumb of the right-hand gripping the first anatomical handle 14 against the palm of the right hand,
the second body 11 by his/her left hand using a second anatomical handle 17, the palm of the left-hand surrounding the second anatomical handle 17, the thumb of the left hand gripping the second anatomical handle 17 against the palm of the left hand.

During handlings of the human-machine interface 1, the first anatomical handle 14 is arranged at the chest of the operator and the second anatomical handle 17 is arranged at the belt of the operator, the longitudinal axis AB able to be parallel to gravity G (FIG. 2) or slanted with respect to gravity G (non represented).

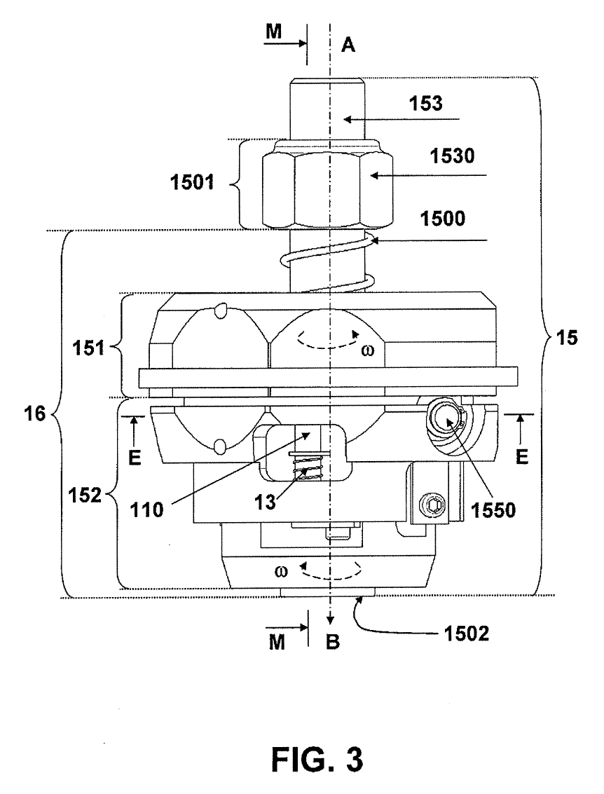

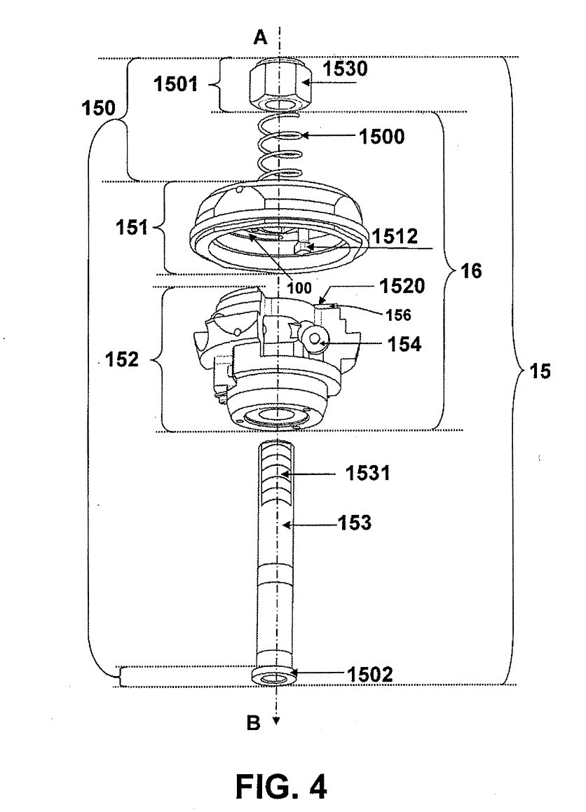

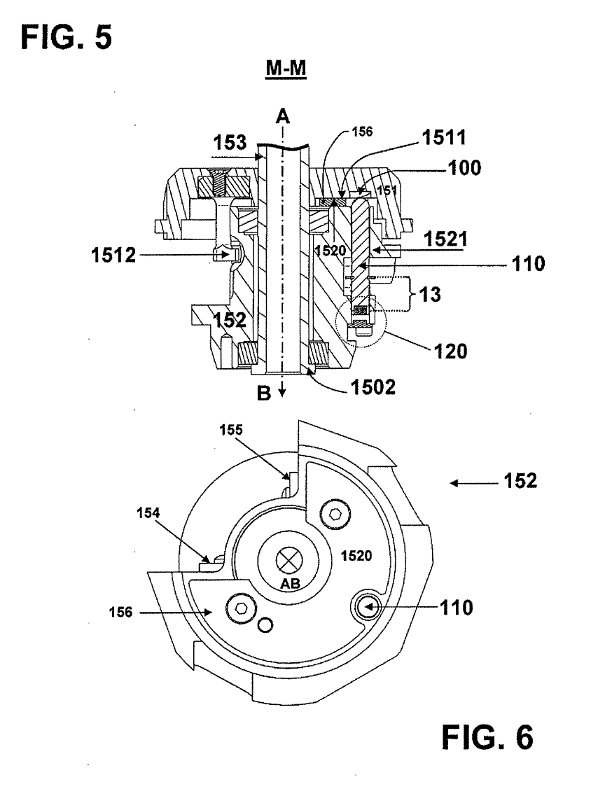

The first and second bodies 10, 11 are rotatably movable (arrow ω on FIGS. 2-3) with respect to each other around the longitudinal axis AB. The first body 10 supports a helical platform 100 extending at a distance from the longitudinal axis AB in a slanted plane with respect to this axis AB (FIG. 4). The second body 11 supports a feeler 110 mounted in sliding contact on the platform 100 (FIGS. 3, 5, 8-9, 11-12, 14-15). The first controller 12 comprises a first sensor 120 (for example, that of “Hall-type effect”) outputting a first signal depending on a position adopted by the feeler 110 on the platform 100 (FIGS. 5, 14). To output the first signal, all the operator has to do is move his/her forearms and elbows apart or bring them close to each other, by thus placing the first and second bodies 10, 11 in relative rotation according to the referenced arrows “ω” on FIG. 2.

According to the invention:
the human-machine interface 1 further comprises at least first urging means 13 capable of applying a first resilient bearing force soliciting the feeler 110 and the platform 100 against each other,
the first and second bodies 10 and 11 are fixed in translation with respect to one another along the longitudinal axis AB, and
one of the elements constituted by the feeler 110 and the platform 100 is slidingly mounted along the longitudinal axis AB with respect to the first and second bodies 10 and 11.

The first sensor 120 may comprise a permanent magnet 1200 placed at an end of the feeler 110 opposed to the platform 100, while facing a Hall sensor 1201 (FIG. 14). Preferably, the magnet 1200 and the Hall sensor 1201 are aligned along a privileged axis of the feeler 110, for example along its symmetry axis CD parallel to the longitudinal axis AB (FIG. 14). In the examples illustrated on FIGS. 1-21:
the feeler 110 is slidingly mounted along the longitudinal axis AB with respect to the second body 11 over a predetermined distance, for example equal to 4 mm,
the feeler 110 is constantly maintained pressed against the platform 100 under the effect of the first resilient bearing force emitted by the first urging means 13 (represented by an urging spring 13 on FIGS. 3, 5, 14). Once the first body 10 is put into rotation with respect to the second body 11, the feeler 110 moves over the platform 100 (FIGS. 9, 12, 15) thus, making the feeler 110 slide with respect to the second body 11 (FIGS. 8, 11, 14). The distance between the magnet 1200 and the Hall sensor 1201 thus, varies according to the position of the feeler 110 over the platform 100, consequently, the Hall sensor 1201 emits the first signal depending on the relative angular position of the first and second bodies 10 and 11.

As illustrated on FIGS. 1-2, the human-machine interface 1 may comprise a second and a third controller 2 and 3, arranged respectively on the second and first body 11 and 10. Preferably, the second and third controllers 2 and 3 each comprise a first and second series of sensors (for example, pressure sensors) adapted to be activated by the fingers (of the left hand and the right hand respectively on FIGS. 1-2) to emit signals (for example, according to pressure forces exerted by the fingers on the sensors).

The first series of sensors is adapted to be activated by distal phalanges, called ungula phalanges, fingers. It is for the second controller 2, second distal sensors referenced on FIGS. 1-2 such that:
second distal sensors 200, 201 and 202 and 202 adapted to be controlled by the distal phalanges of the index of the left hand,
second distal sensor 210 adapted to be controlled by the distal phalange of the middle finger of the left hand,
second distal sensor 220 adapted to be controlled by the distal phalange of the annular of the left hand,
second distal sensors 230, 232 and 233 adapted to be controlled by the distal phalange of the auricular of the left hand, and,

for the third controller 3, third distal sensors referenced on FIGS. 1-2 such that:
third distal sensors 300, 301 and 302 adapted to be controlled by the distal phalange of the index of the right hand,
third distal sensor 310 adapted to be controlled by the distal phalange of the major of the right hand,
third distal sensor 320 adapted to be controlled by the distal phalange of the annular of the right hand,
third distal sensors 330, 332 and 333 adapted to be controlled by the distal phalange of the auricular of the right hand.

The second series of sensors is adapted to be activated by proximal phalanges, called first phalanges. For the second controller 2, it is second proximal sensors referenced on FIGS. 1-2 such that:
second proximal sensor 20 adapted to be controlled by the proximal phalange of the index of the left hand,
second proximal sensor 21 adapted to be controlled by the proximal phalange of the major of the left hand,
second proximal sensor 22 adapted to be controlled by the proximal phalange of the annular of the left hand,
second proximal sensors 23 and 231 adapted to be controlled by the proximal phalange of the auricular of the left hand, and, p for the third controller 3, third proximal sensors referenced on FIGS. 1-2 such that:
third proximal sensor 30 adapted to be controlled by the proximal phalange of the index of the right hand,
third proximal phalange 31 adapted to be controlled by the proximal phalange of the major of the right hand,
third proximal sensor 32 adapted to be controlled by the proximal phalange of the annular of the right hand,
third proximal sensors 33 and 331 adapted to be controlled by the proximal phalange of the auricular of the right hand.

Such as illustrated on FIG. 2, the human-machine interface 1 is provided with a telecommunication module 4, preferably, wireless, with a remote information processing center (for example, with a remote computer 40 adapted to process data) which is in turn linked to an electronic equipment (for example with an electronic musical equipment 41 adapted to reproduce sounds and/or lighting). The telecommunication module may comprise an embedded central unit, means for transmitting and receiving data in order to ensure an exchange of signals between the controllers 12, 2, 3 and the information processing centre 40.

Preferably, the human-machine interface 1 further comprises second urging means 150, different from first urging means 13 and able to exert a second resilient bearing force making the first and second bodies 10 and 11 closer to each other along the longitudinal axis AB (FIG. 2).

Such as illustrated on FIGS. 3-5, the human-machine interface 1 may further comprise a module 15 including first and second portions 151 and 152 and the second urging means 150. The first and second portions 151 and 152 are respectively fixed to the first and second bodies 10 and 11 (for example, using fixing screws 101 and 111 respectively, such as illustrated on FIG. 2). The first and second portions 151 and 152 are fixed in translation and rotatably movable with respect to each other around the longitudinal axis AB (arrow ω on FIG. 3). The second resilient bearing force brings the first and second portions, 151 and 152 of the module 15 closer to each other along the longitudinal axis AB.

Advantageously, such as illustrated on FIGS. 3-5, the module 15 further comprises an axial shaft 153. The second urging means 150 comprise at least a spring 1500 and two bearing members 1501 and 1502, supported by the shaft 153 and whereof one at least includes a screw 1503 engaged on a threading 1531 of the shaft 153. The two portions 151 and 152 of module 15 and the spring 1500 together form a stacking 16 axially traversed by the shaft 153 and squeezed between the two bearing members 1501, 1502. The second resilient bearing force is exerted in an adjustable manner by a load of the spring 1500 resulting from a screwing of the screw 1530 on the shaft 153.

Such as illustrated on FIGS. 4-6, the first and second portions 151, 152 of module 15 exhibit respective friction surfaces 1511, 1520 applied against each other, of identical or different nature, and whereof each is at least constituted of a material that is selected from the set comprising: aluminum, metal or a metal alloy, plastic material, and polyoxymethylene.

Advantageously, the module 15 may further comprise a friction pad 156 arranged, along the longitudinal axis AB, between the first and second parts 151, 152 (FIGS. 4-5). The friction pad 156 is secured to one amongst the first or the second portions 151, 152 (with the second portion 152 on FIGS. 4-6). One at least amongst the friction surfaces 1511, 1520 (for example, the friction surface 1520 of the second portion 152 of the module 15 on FIGS. 4-6) may be that of the friction pad 156.

Owing to this arrangement, it is possible to facilitate a fabrication of the module 15. In the examples illustrated on FIGS. 4-6, it is possible to achieve the second portion 152 in metal (which is easy to fabricate unlike certain plastic material), then selectively adjust the friction force between the first and the second portions 151, 152 using the manufactured friction pad 153, for example, in a more fragile plastic material.

Preferably, a friction couple “friction pad 156/first portion 151 of the module 15” may be selected so that the friction pad 156 wears down more easily than the first portion 151 of the module 15. Thus, in the presence of the friction pad 156 (easy to replace), the first portion 151 of the module becomes almost unusable, which makes the human-machine interface 1 maintenance operations easier.

Advantageously, the helical platform 100 takes the form of a frontal surface on the first portion 151 of the module 15 (FIGS. 4-5, 8-9, 11-12, 14-15, 17-18, 20-21). The feeler 110 takes the form of a stud 110 slidingly mounted, under the solicitation of the first resilient bearing force, parallel to the longitudinal axis AB and in a housing 1521 of the second portion 152 of the module 15. The first sensor 120 is responsive to the sliding position of the stud 110.

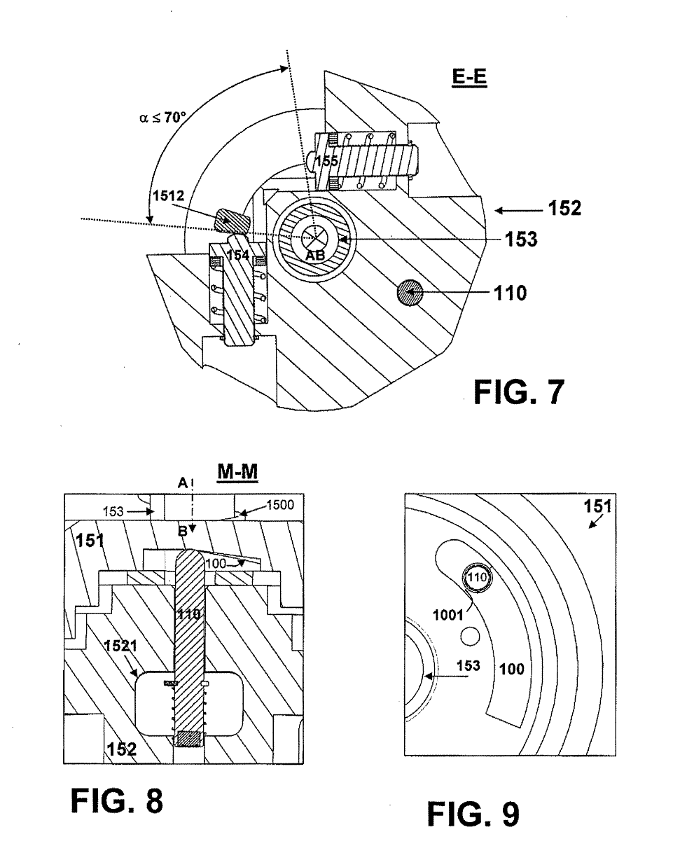

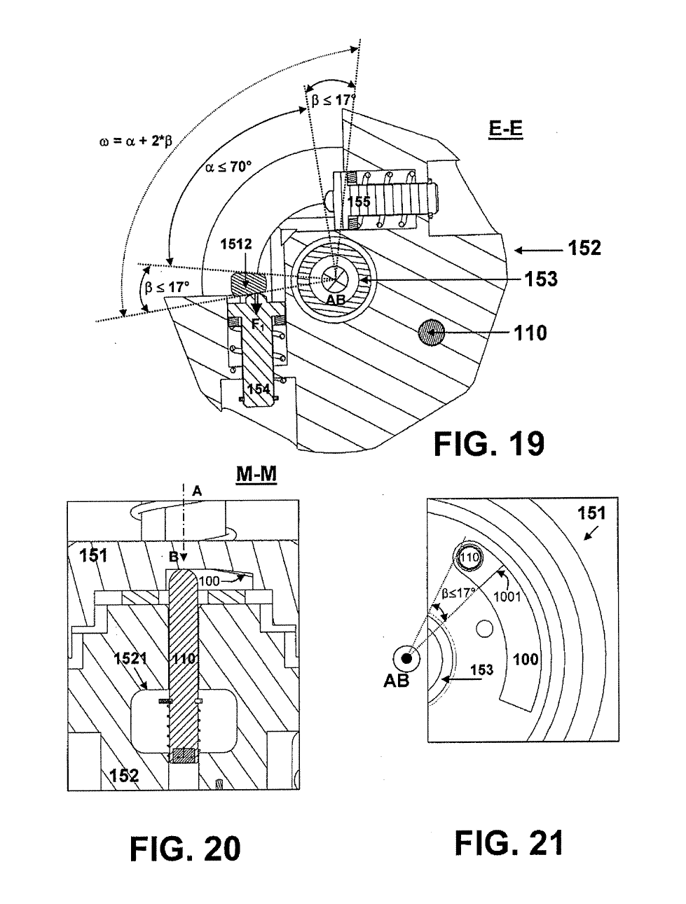

Preferably, the platform 100 offers the feeler 110 a effective travel 1000 corresponding to a relative rotation of the two bodies around the longitudinal axis AB at the most equal to 70° (referenced by the angle α≦70° on FIGS. 7, 10, 12, 13, 16, 19). The module 15 further comprises at least a first elastic end-of-travel stop 154 limiting the travel of the feeler 110 to a first end 1001 of the platform 100 (FIGS. 7 and 9). The first elastic stop 154 at least is provided with a second sensor 1540 outputting a second control signal depending on a first effort F₁, exerted on this first elastic stop 154 (FIG. 19).

In order to optimize the adaptation of the human-machine interface 1 to the operators morphology, the angle α particular to the effective travel 1000 is preferably at the most equal to 65°.

In an advantageous manner, the module 15 further comprises at least a second end-of-travel stop 155 limiting the travel of the feeler 110 to the second end 1002 of the platform 100, at a distance from the first end 1001. The second elastic stop 155 may itself be provided with a third sensor 1550 outputting a third control signal depending on a second effort F₂ exerted on this second elastic stop 155.

In order to simplify the use of the human-machine interface 1 for the operator, the first effort F₁ and the second effort F₂ are preferably equivalent to each other.

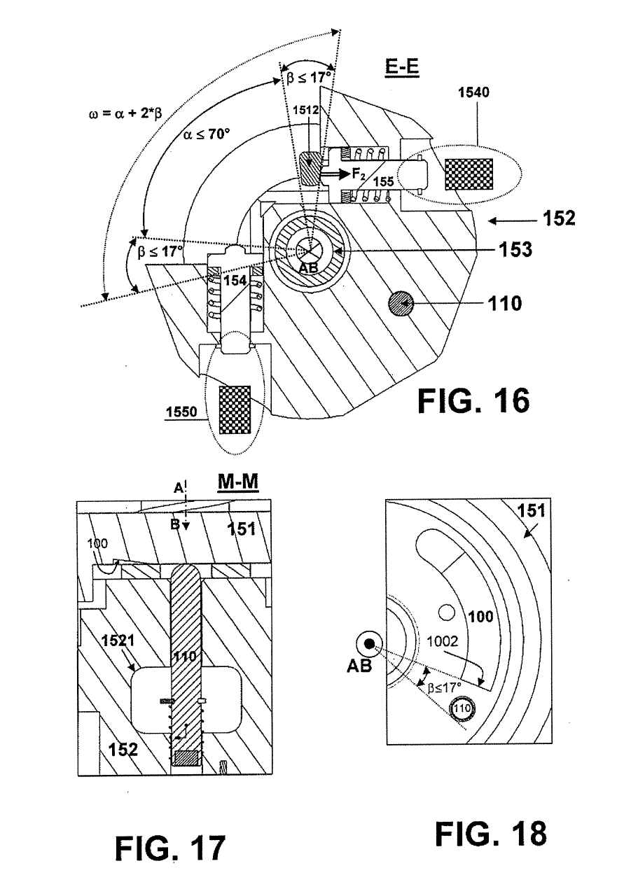

Advantageously, each elastic stop 154 and 155 is adapted in order to limit the relative rotation of the two bodies 10 and 11 around the longitudinal axis AB of an angle β at the most equal to 17° (angle β≦17° on FIGS. 16, 18, 19, 21) beyond the effective travel of the feeler 110 over the platform 100.

In order to optimize the ergonomics of the human-machine interface 1, the angle β which limits the relative rotation of the two bodies 10 and 11 with each elastic stop 154 and 155, is preferably equal to 16.5°.

As illustrated on FIGS. 16 and 19, the relative global rotation of the two bodies 10, 11 around the longitudinal axis AB is possible on an obtuse total rotation angle ω, preferably, on an obtuse total rotation angle co such that ω=α+2*β≦104°, where the angle α is relative to the effective travel 1000, and where the angle β is relative to the limitation of the relative rotation of the two bodies 10 and 11 with each elastic stop 154 and 155.

Thanks to this angle u of total rotation at the most equal to 104°, it is possible to keep the fingers of the left and right hand free, including when the operator handles the human-machine interface such as to slant the longitudinal axis AB of the human-machine interface 1 with respect to gravity G. For example, it is possible to simultaneously activate:
with the right hand
the third distal sensor 300 with the distal phalange of the index and the third proximal sensor 30 with the proximal phalange of the index,
the third distal sensor 310 with the distal phalange of the major and the third proximal sensor 31 with the proximal phalange of the major,
the third distal sensor 320 with the distal phalange of the annular and the third proximal sensor 32 with the proximal phalange of the annular.
The third distal sensor 330 with the distal phalange of the auricular and the third proximal sensor 33 with the proximal phalange of the auricular.
with the left hand:
the second distal sensor 200 with the distal phalange of the index and the second proximal sensor 20 with the proximal phalange of the index,
the second distal sensor 210 with the distal phalange of the major and the second proximal sensor 21 with the proximal sensor of the major,
the second distal sensor 220 with the distal phalange of the annular and the second proximal sensor 22 with the proximal phalange of the annular,
the second distal sensor 230 with the distal phalange of the auricular and the second proximal sensor 23 with the proximal phalange of the auricular,

the operator being for example bent-over, in order to slant the longitudinal axis AB of the human-machine interface 1 with respect to gravity G, the forearms and the elbows of the operator being spread such that the total rotation angle o is equal to 104°.

Each elastic stop 154 and 155 is provided on one of the two portions 152 of the module 15. A spur 1512, parallel to the stud 110 and fixed to the other portion 151 of the module 15 (FIG. 4), is provided for pressing on each elastic end-of-travel stop 154 and 155 of the stud 110 on the platform 100 (FIGS. 16, 19).

By analogy with the first sensor 120 outputting the first control signal, the second sensor 1540 outputting the second control signal and the third sensor 1550 outputting the third control signal are for example of “Hall-type effect”. Likewise for the second and third distal sensors [200, 201, 202, 210, 220, 230, 232, 233] and [300, 301, 320, 330, 332, 333] as well as for the second and third proximal sensors [20, 21, 22, 23, 231] and [30, 31, 32, 33, 331] mentioned here below with respect to the second and third controllers 2 and 3.

1.-9. (canceled)

10. A human-machine interface comprising:
a first body;
a second body linked to the first body and aligned along a longitudinal axis (AB), wherein the first body and the second body are rotatably movable within respect to each other around the longitudinal axis (AB) and fixed in translation with respect to each other along the longitudinal axis;
a first controller including a first sensor,
a helical platform supported by the first body, the helical platform extending a distance from the longitudinal axis and having a tangent plane that is slanted with respect to the longitudinal axis (AB);
a feeler supported by the second body and mounted in sliding contact with the helical platform, wherein the sensor of the first controller outputs a first signal depending on a position adopted by the feeler on the helical platform, and wherein one of the feeler and the platform are slidingly mounted along the longitudinal axis (AB) with respect to the first and second bodies;
a first urging means for applying a first resilient bearing force to urge the feeler and the helical platform against each other; and
a second urging means for exerting a second resilient bearing force that tends to make the first and second bodies closer to each other along the longitudinal axis.

11. The human-machine interface according to claim 10, further comprising:
a module having a first portion, a second portion and including the second urging means, wherein the first and second portions are respectively fixed to the first and second bodies in that the first and second portions are fixed in translation and rotatably movable with respect to each other around the longitudinal axis (AB) such that the second resilient bearing force from the second urging means tends to make the first and second portions of the module closer to each other along the longitudinal axis (AB).

12. The human-machine interface according to claim 11, wherein the module further comprises an axial shaft, and the second urging means comprises at least a spring and two bearing members supported by the shaft, and wherein one or both of the bearing members includes a screw engaged on a threading of the shaft such that the two portions of the module and the spring together form a stacking axially traversed by the shaft and squeezed between the two bearing members such that the second resilient bearing force is exerted in an adjustable manner by a load of the spring resulting from a screwing of the screw on the shaft.

13. The human-machine interface according to claim 11, wherein the first and second portions of the module exhibit respective friction surfaces as applied against each other, of identical or different nature, and each one of which is at least constituted of a material selected from the group consisting of: aluminum, metal or metal alloy, plastic material, and polyoxymethylene.

14. The human-machine interface according to claim 12, wherein the first and second portions of the module exhibit respective friction surfaces as applied against each other, of identical or different nature, and each one of which is at least constituted of a material selected from the group of: aluminum, metal or metal alloy, plastic material, and polyoxymethylene.

15. The human-machine interface according to claim 12, wherein the helical platform defines a frontal surface of the first portion of the module and wherein a the feeler defines a stud slidingly mounted, under the urging influence of the first resilient bearing force and parallel to the longitudinal axis in a housing of the second portion of the module, and further wherein the first sensor is responsive to the sliding position of the stud.

16. The human-machine interface according to claim 13, wherein the helical platform defines a frontal surface of the first portion of the module and wherein a the feeler defines a stud slidingly mounted, under the urging influence of the first resilient bearing force and parallel to the longitudinal axis in a housing of the second portion of the module, and further wherein the first sensor is responsive to the sliding position of the stud.

17. The human machine-interface according to claim 14, wherein the helical platform defines a frontal surface of the first portion of the module and wherein a the feeler defines a stud slidingly mounted, under the urging influence of the first resilient bearing force and parallel to the longitudinal axis in a housing of the second portion of the module, and further wherein the first sensor is responsive to the sliding position of the stud.

18. The human-machine interface according to claim 14, wherein the helical platform provides the feeler with an effective travel corresponding to a relative rotation of the first body and the second body about the longitudinal axis (AB) a maximum of at or about equal 70°, and wherein the module further comprises an elastic end-of-travel stop limiting the travel of the feeler to a first end of the helical platform, and further wherein the first resilient bearing force includes a second sensor that outputs a second control signal depending on a first effort experienced by the elastic end-of-travel stop.

19. The human-machine interface according to claim 15, wherein the helical platform provides the feeler with an effective travel corresponding to a relative rotation of the first body and the second body about the longitudinal axis (AB) a maximum of at or about equal 70°, and wherein the module further comprises an elastic end-of-travel stop limiting the travel of the feeler to a first end of the helical platform, and further wherein the first resilient bearing force includes a second sensor that outputs a second control signal depending on a first effort experienced by the elastic end-of-travel stop.

20. The human-machine interface according to claim 16, wherein the helical platform provides the feeler with an effective travel corresponding to a relative rotation of the first body and the second body about the longitudinal axis (AB) a maximum of at or about equal 70°, and wherein the module further comprises a first elastic end-of-travel stop limiting the travel of the feeler to a first end of the helical platform, and further wherein the first resilient bearing force includes a second sensor that outputs a second control signal depending on a first effort experienced by the first elastic end-of-travel stop.

21. The human-machine interface according to claim 14, wherein the module further comprises a second elastic end-of-travel stop limiting the travel of the feeler to a second end of the helical platform at a pre-determined distance from the first end of the helical platform, and wherein the second elastic end-of-travel stop includes a third sensor that outputs a third control signal depending on a second effort experienced by this second elastic end-of-travel stop.

22. The human-machine interface according to claim 19, wherein the module further comprises a second elastic end-of-travel stop limiting the travel of the feeler to a second end of the helical platform at a pre-determined distance from the first end of the helical platform, and wherein the second elastic end-of-travel stop includes a third sensor that outputs a third control signal depending on a second effort experienced by this second elastic end-of-travel stop.

23. The human-machine interface according to claim 20, wherein the module further comprises a second elastic end-of-travel stop limiting the travel of the feeler to a second end of the helical platform at a pre-determined distance from the first end of the helical platform, and wherein the second elastic end-of-travel stop includes a third sensor that outputs a third control signal depending on a second effort experienced by this second elastic end-of-travel stop.

24. The human-machine interface according to claim 21, wherein each elastic stop limits the relative rotation of the first body and the second body around the longitudinal axis at the most equal to 17° beyond the effective travel of the feeler on the helical platform.

25. The human-machine interface according to claim 22, wherein each elastic stop limits the relative rotation of the first body and the second body around the longitudinal axis at the most equal to 17° beyond the effective travel of the feeler on the helical platform.

26. The human-machine interface according to claim 23, wherein each elastic stop limits the relative rotation of the first body and the second body around the longitudinal axis at the most equal to 17° beyond the effective travel of the feeler on the helical platform.

27. The human-machine interface according to claim 21, wherein each elastic stop is provided on one of the first and second portions of the module, and wherein the module further includes a spur fixed to the other portion of the module parallel to the stud, and further wherein the spur selectively engages each of the elastic stop at the end of travel of the stud on the platform.

28. The human-machine interface according to claim 22, wherein each elastic stop is provided on one of the first and second portions of the module, and wherein the module further includes a spur fixed to the other portion of the module parallel to the stud, and further wherein the spur selectively engages each of the elastic stop at the end of travel of the stud on the platform.

29. The human-machine interface according to claim 23, wherein each elastic stop is provided on one of the first and second portions of the module, and wherein the module further includes a spur fixed to the other portion of the module parallel to the stud, and further wherein the spur selectively engages each of the elastic stop at the end of travel of the stud on the platform.

30. The human-machine interface according to claim 24, wherein each elastic stop is provided on one of the first and second portions of the module, and wherein the module further includes a spur fixed to the other portion of the module parallel to the stud, and further wherein the spur selectively engages each of the elastic stop at the end of travel of the stud on the platform.
